(19) United States
(12) Patent Application Publication
(10) Pub. No.: US 2009/0240825 A1
(43) Pub. Date: Sep. 24, 2009

(54) DELIVERING STREAMING DATA

(75) Inventors: Winfried Antonius Henricus Berkvens, Eindhoven (NL); Jurjen Eisink, Eindhoven (NL)

Correspondence Address: VOLPE AND KOENIG, P.C., UNITED PLAZA, SUITE 1600, 30 SOUTH 17TH STREET, PHILADELPHIA, PA, 19103, US

(73) Assignee: KONINKLIJKE PHILIPS ELECTRONICS, N.V., EINDHOVEN (NL)

(21) Appl. No.: 11/721,340

(22) PCT Filed: Dec. 5, 2005
(86) PCT No.: PCT/IB05/54058

§ 371 Date: Jun. 11, 2007

(30) Foreign Application Priority Data
Dec. 13, 2004 (EP) 04106495.7

(51) Int. Cl. H04L 12/56; G06F 15/16

(52) U.S. Cl. 709/231; 370/401

(57) ABSTRACT

A method of delivering streaming data to a user device comprises delivering a first data stream supplied by a data server to a user device via a router, and receiving a change request from the user device, the change request being indicative of a second data stream required by the user device. A data server having the second data stream available for delivery to the router is identified, and the second data stream is delivered from the identified data server to the router. Delivery of the first data stream to the user device is ceased, and, after such cessation of delivery of the first data stream, delivery of the second data stream to the user device commences.

The present invention relates to delivering streaming data, for example streaming video and/or audio data.

Most of real-time streaming of content, like radio broadcasts and TV broadcasts, is currently performed by constantly having a channel reserved for each station, and receiving the content continuously via these channels. The user's reception apparatus then selects the chosen channel for output. Such a system requires bandwidth to be reserved for each station for each user; independently of whether the user is actually listening to or watching a particular station.

There is currently a change to a networked environment in which Internet Protocol (IP) has a central role for delivering of information. It is to be expected that radio and TV broadcasts will increasingly use IP networks to deliver their content to the user. The most common IP technique to deliver such streaming data is known as “HTTP-Get”. This technique is based on a point-to-point connection, and suits current needs due to the fact that the number of users is small. As the number of users using IP networks for streaming content increases (and so the number of users requesting a service from a station increases), the HTTP-Get technique does not really scale. The reason for this is the tremendous network load (e.g. bandwidth) required, as well as the capacity that a network server requires to service a large amount of requests. This load can lead to network congestion.

In order to overcome these disadvantages, a multicast model can be used. In a multicast model, content is transferred only once to a router/switch independent from the number of users receiving the data stream via this router/switch. This reduces the network load. The multicast protocol used in the Internet world to provide this service is IGMP [IETF-RFC3376]

Currently the bandwidth on the last part of the network, that is the wired network between service provider and the home network of the user, and/or the wireless network between an access point and a portable device is the home network, is generally not sufficient to support the reception of two multicast stations at the same time. In such a case, it is necessary to change from a first station to a second by stopping the reception of the first station and then requesting the reception of the second one. The current version of the IGMP protocol (version 3) supports this option. Such a technique, however, introduces a certain amount of time that neither of the two streams is received by the user's device and which leads to things like a frozen/blue screen (for TV reception) or a silence (for radio reception). This is not desirable for the user. In addition, the temporarily unused and unclaimed bandwidth (during the switch) could be taken over by another data stream which in that case would result in no available bandwidth for the new stream leading to no reception at all.

One possible alternative solution is to increase the bandwidth of the last part of the network. However, it is difficult to raise the bandwidth sufficiently in all cases.

It is known from Patent Application WO 0126271, to increase the speed for the user of switching from one station to another. However, such a solution assumes the availability of enough bandwidth to receive multiple stations in parallel. Also, since it is assumed that all stations cannot be received in parallel, there will be the problem in the case when a non currently received station is chosen.

According to one aspect of the present invention, there is provided a method of delivering streaming data to a user device, the method comprising: delivering a first data stream to a user device via a router, the first data stream being supplied by a data server; receiving a change request from the user device, the change request being indicative of a second data stream required by the user device; identifying a data server having the second data stream available for delivery to the router; delivering the second data stream from the identified data server to the router; ceasing delivery of the first data stream to the user device; and, after such cessation of delivery of the first data stream, commencing delivery of the second data stream to the user device.

According to another aspect of the present invention, there is provided a system for delivering streaming data to a user, the system comprising:

first and second content providers for supplying data relating to first and second content streams respectively;

a network comprising a router for receiving selectively first and second content streams, and for delivering the first or second content stream to a user device; and

a user device for receiving a first or second content stream from the router, wherein the system is operable, in response to a request received from a user device, to cease delivery of a first content data stream from the router to the user device, and to commence delivery of a second content data stream to the user device after cessation of delivery of the first content data stream.

According to another aspect of the present invention, there is provided a router for use in delivering streaming data to a user device, the router comprising:

a reception unit for receiving data relating to first and second content streams from first and second content providers respectively; and

a delivery unit for delivering the first or second content stream to a user device, and operable, in response to a request received from a user device, to cease delivery of a first content data stream to that user device, and to commence delivery of a second content data stream to that user device after cessation of delivery of the first content data stream thereto.

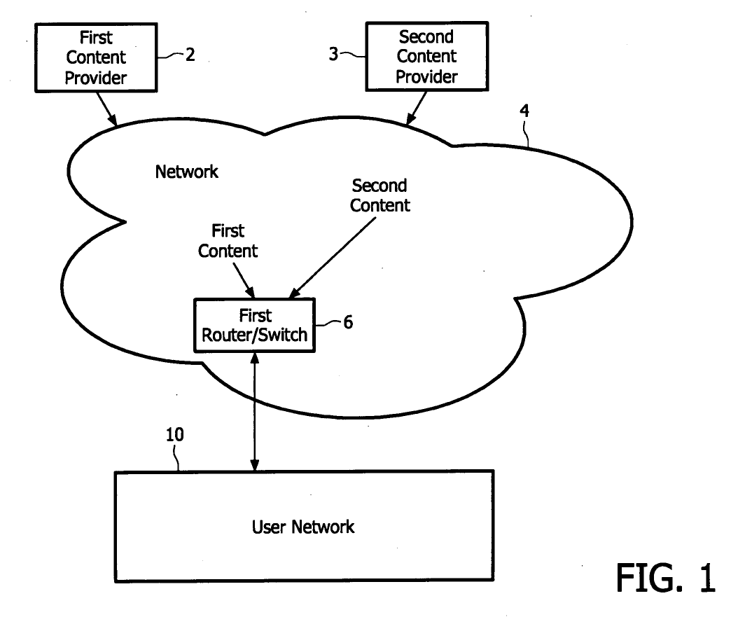

FIG. 1 is a block diagram illustrating a network arrangement embodying an aspect of the present invention;

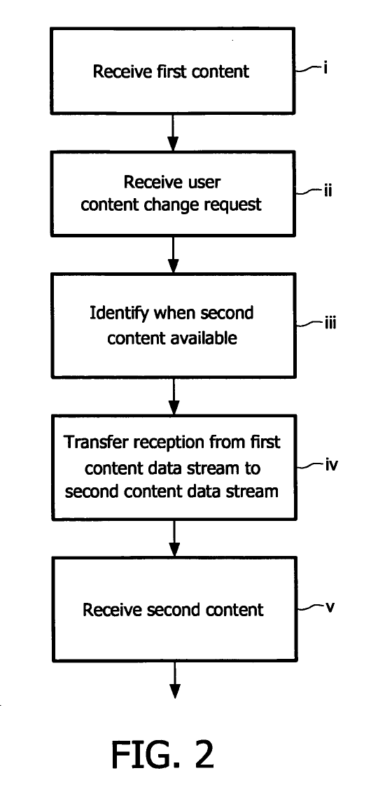

FIG. 2 is a flow diagram illustrating a method embodying an aspect of the present invention; and

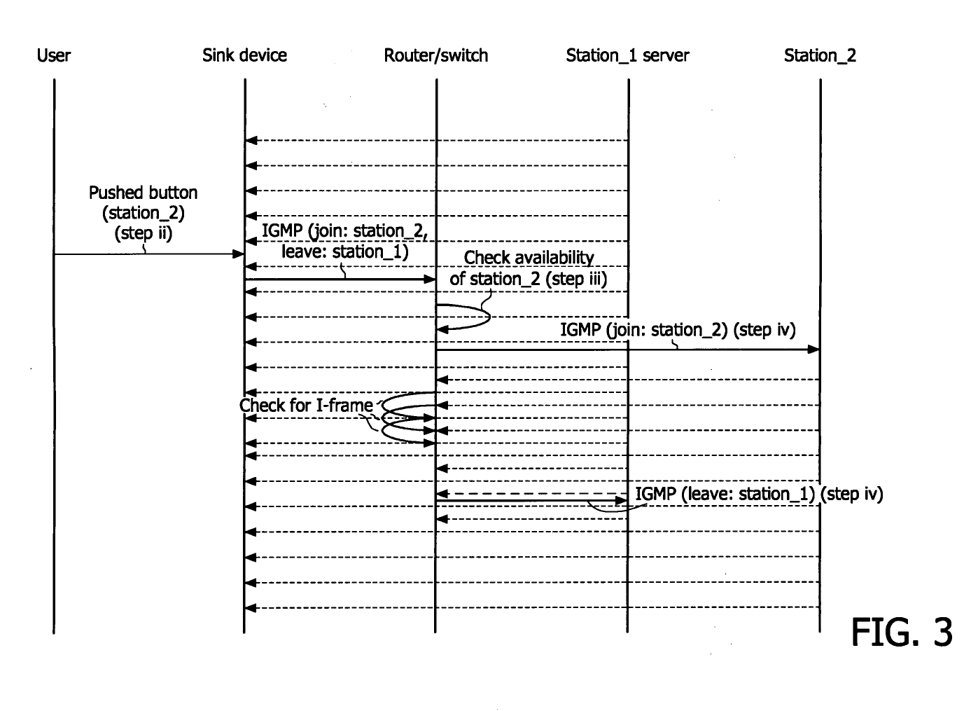

FIG. 3 is a timing diagram relating to a method embodying the present invention.

FIG. 1 is a block diagram illustrating a system for providing streamed data to a user. First and second content providers 2 and 3 provide first and second content respectively to a network. The network 4 can be provided by any appropriate network switches, servers and routers, and supplies the first content from the first content provider 2 to a user network 10 via a router/switch 6. The second content is provided by the second content provider 3 via the router/switch 6 of the network 4 to the user network 10.

The present invention is concerned with switching between the first and second content at the user network 10. A method embodying the present invention will now be described with reference to FIG. 1 and the flow chart of FIG. 2. At step i, the first content is received from the router/switch 6. A user content change request (channel change request) is received at step ii, and the system then identifies whether the first router/switch 6 has the second content available for supply to the user network (step iii). Once the router/switch 6 has been identified as having the second content data stream available to the user, content reception is switched (step iv), such that the user network now receives the second content from the router/switch 6 (step v). The data stream of the first content from the router/switch 6 is halted before the data stream of the second content is commenced from the router/switch 6. In a preferred embodiment, the cessation of the delivery of the first content data stream and the commencement of the second content data stream occurs substantially simultaneously.

FIG. 3 is a timing diagram illustrating timing of the method of FIG. 2.

It will be appreciated that the first and second content data streams can be provided by the same content provider. This content provider can be a content data server or equivalent.

An embodiment of the present invention provides an update to IGMP version 3. It swaps the first content data stream with the requested second content data stream on the link, from the router/switch 6 (of the service provider) to the home network 10 of the user (or from the wireless access point to the portable device), at the moment the user requests the station change and the new stream is available at the router/switch 6.

The solution can be used recursively in the network 4 as long as no other user had requested the same old station (the one being replaced by the new station) at the same router/switch.

As an extra addition, the component responsible for changing the forwarding from the first content to the second content in the router/switch, could be made intelligent, such that the moment the change from the first content to the second content is to be made is chosen so that the first packet from the new source/station sent to the user contains the beginning of an I-frame (MPEG case). In this case, no unnecessary packets would be sent to user.

A first advantage of an embodiment of the invention is that no frozen/blue screen or silence is noticeable by the user. The only noticeable experience will possibly be a very short freezing of the image/or a very short sound disruption. However, since this is similar to the current situation with ordinary TV reception or radio reception when a new station is selected, it is deemed to be acceptable.

A second advantage of an embodiment of the current invention is that there is no need for a new admission control step or bandwidth reservation step in the procedure every time that a new source/station is selected, since the same router and link (between router/switch 6 and home network 10) is used to provide the first and second content data streams.

Furthermore, embodiments of the present invention do not require any extra bandwidth (during station change) than the maximum required bandwidth of one of the two streams. This means that no interruptions will occur (during station change) due to lost data packets.

1-9. (canceled)

10. A method of delivering streaming data to a user device (10), the method comprising:
delivering a first content data stream to a user device (10) via a router (6), the first content data stream being supplied by a first content provider (2);
receiving a change request from the user device (10), the change request being indicative of a second content data stream required by the user device (10);
identifying a second content provider (3) having the second content data stream available for delivery to the router (6);
delivering the second content data stream from the identified second content provider (3) to the router (6);
ceasing delivery of the first content data stream to the user device, and, after such cessation of delivery of the first content data stream, commencing delivery of the second content data stream to the user device (10) from the router (6).

11. A method as claimed in claim 10, wherein the change request is in the form of an IGMP message.

12. A method as claimed in claim 10, wherein ceasing delivery of the first content data stream to the user device (10) occurs simultaneously with commencement of delivery of the second content data stream to the user device (10) from the router (6).

13. A method as claimed in claim 10, wherein the first and second data servers are provided by a single data server (2, 3).

14. A system for delivering streaming data to a user, the system comprising:
first and second content providers (2, 3) for supplying data relating to first and second content streams respectively;
a network comprising a router (6) for receiving selectively first and second content streams, and for delivering the first or second content stream to a user device (10); and
a user device (10) for receiving a first or second content stream from the router (6), wherein the system is operable, in response to a request received from a user device, to cease delivery of a first content data stream from the router (6) to the user device (10), and to commence delivery of a second content data stream to the user device (10) after cessation of delivery of the first content data stream.

15. A system as claimed in claim 14, wherein the first and second content providers are provided by a single data server.

16. A system as claimed in claim 14, wherein the change request is in the form of an IGMP message.

17. A router for use in delivering streaming data to a user device, the router comprising:
a reception unit for receiving data relating to first and second content streams from first and second content providers respectively; and
a delivery unit for delivering the first or second content stream to a user device, and operable, in response to a request received from a user device, to cease delivery of a first content data stream to that user device, and to commence delivery of a second content data stream to that user device after cessation of delivery of the first content data stream thereto.

18. A router as claimed in claim 17, wherein the change request is in the form of an IGMP message.
